(19) United States
(12) Patent Application Publication
(10) Pub. No.: US 2006/0209007 A1
(43) Pub. Date: Sep. 21, 2006

(54) Method and apparatus for controlling electrochromic device

(76) Inventors: Uksun Pyo, Daejeon-city (KR); Heedeog Kim, Seoul (KR)

Correspondence Address: CANTOR COLBURN, LLP, 55 GRIFFIN ROAD SOUTH, BLOOMFIELD, CT, 06002, US

(21) Appl. No.: 11/365,014

(22) Filed: Mar. 1, 2006

(30) Foreign Application Priority Data
Mar. 16, 2005 (KR) 10-2005-0021865
Jan. 9, 2006 (KR) 10-2006-0002383

(51) Int. Cl. G09G 3/38

(52) U.S. Cl. 345/105

(57) ABSTRACT

Provided are a method and apparatus for controlling an ECD for reducing power consumption of the ECD. In The the method for of controlling an ECD coloredcoloring and decolored discoloring of an ECD by using a coloring voltage and a discoloring voltage, does not apply the coloring voltage and the discoloring voltage are not applied to the ECD after a lapse of predetermined time is passed from the time when the coloring voltage and the discoloring voltages are applied to the ECD. The apparatus for controlling an ECD blocks the coloring voltage and the discoloring voltage applied to the ECD after a lapse of predetermined time is passed from the start of coloring and discoloring operations to reduce power consumption of the ECD.

### CROSS-REFERENCE TO RELATED PATENT APPLICATION

This application claims the benefit of Korean Patent Applications No. 10-2005-0021865, filed on Mar. 16, 2005, and No. 10-2006-0002383, filed on Jan. 9, 2006, in the Korean Intellectual Property Office, the disclosures of which are incorporated herein in their entirety by reference.

### BACKGROUND OF THE INVENTION

1. Field of the Invention

The present invention relates to an apparatus for controlling an electrochromic device (ECD), and more particularly, to a method and apparatus for reducing power consumed by the ECD.

2. Description of the Related Art

A room-mirror of a vehicle is attached in the front of a room of the vehicle in general in order that a driver can look at the situation in the rear of the vehicle without turning his/her head around. However, strong head-light from the vehicle in the rear can cause interference of safety operations and also aggravate a degree of fatigue of driver's eyes when it is reflected by the room-mirror because the driver feels dazed by it.

Accordingly, various techniques to block glare of the light from the rear by giving the room-mirror and a side-mirror the ability to change its color have been studied.

As a glare-free mirror, an ECD is mostly used, which is disclosed in U.S. Pat. Nos. 4,902,108, No. 4,204,778, No. 4,278,693, No. 5,282,077, No. 5,336,448, No. 5,448,397, No. 5,451,822 and No. 6,512,624. The ECD is a kind of display device including a material capable of bringing out achanging color according to an oxidation and reduction reaction when a voltage is applied thereto. The ECD is adapted to a smart windows, a temperature sensors, a vehicle mirrors, an optical shutters and so on to control the quantity of light.

FIG. 1 is a cross-sectional view of a conventional ECD. Referring to FIG. 1, the ECD includes first and second glass substrates 102 and 104 arranged in parallel with each other spacing at a predetermined distance, transparent electrodes 106 and 108 respectively formed on the first and second glass substrates 102 and 104, first and second EC layers 110 and 112 respectively formed in a predetermined thickness on the transparent electrodes 106 and 108 with predetermined thickness, and an electrolyte layer 114 formed between the first and second EC layers 110 and 112. The first EC layer 110 uses is formed of a Wo3 layer while the second EC layer 112 uses is formed of a NiO film. The electrolyte layer 114 uses is formed of a liquid electrolyte layer, a gel-type electrolyte layer or a solid electrolyte layer.

FIG. 2 illustrates the configuration of a conventional ECD controller. Referring to FIG. 2, the ECD controller includes a resistor 202 and a photoconductive cell (ex, CDS) 204 serially connected between a power supply voltage B+ and a ground voltage, a comparator 206 comparing a voltage applied to the photoconductive cell 204 to a predetermined reference voltage Vref and outputting a logic signal, a switch 208 opened or closed in response to the output logic signal of the comparator 206, and an ECD 210 operated by the power supply voltage B+ when the switch 208 is closed.

The resistance of the photoconductive cell 204 has a resistance varied witch varies depending on the quantity of light input thereto, for example, light from the headlight of vehicle in the rear, and thus a voltage Vsense applied to the photoconductive cell 204 is varied. The voltage applied to the photoconductive cell 204 is compared to the reference voltage Vref by the comparator 206. The voltage Vsense applied to the photoconductive cell 204 decreases when the quantity of light input from the rear is large. When the voltage Vsense applied to the photoconductive cell 204 becomes lower than the reference voltage Vref, a negative logic signal is output from the comparator 206. The switch 208 is closed by the negative logic signal.

When the switch 208 is closed, the power supply voltage B+ is applied to the ECD 210 and the ECD 210 is colored by the power supply voltage B+. The colored ECD 210 less does not reflect as much light from the headlight of vehicle in the rear than as the uncolored ECD before colored, and thus a driver cannot be dazzled.

When the quality quantity of light from the headlight of vehicle in the rear is reduced, the voltage Vsense applied to the photoconductive cell 204 is increased. When the voltage Vsense applied to the photoconductive cell 204 becomes higher than the reference voltage Vref, a positive logic signal is output from the comparator 206. The switch 208 is opened by the positive logic signal.

When the switch 208 is opened, the power supply voltage B+ is not applied to the ECD 210 and thus coloring of the ECD 210 is stopped and the ECD 210 is gradually discolored according to an oxidation/reduction operation thereof. The conventional ECD controller shown illustrated in FIG. 2 applies a coloring voltage (the power supply voltage B+ of FIG. 2) to the ECD 210 when coloring and blocks the coloring voltage when discoloring. Furthermore, the ECD controller may apply a discoloring voltage when discoloring in order to accelerate discoloring operation.

The currently used ECD rearview mirror has a considerably slow response speed ranged 3 through 6 seconds and relatively large power consumption by the ECD because the coloring voltage and discoloring voltage applied to the ECD are remained after when the ECD is colored and discolored completely.

When the quantity of light input from the rear becomes a normal stateis normalized, that is, the quantity of light decreases to a degree at which a driver may not be dazzled, the ECD rearview mirror should be discolored as soon as possible. If not so, it happens to occur that the driver hardly observes secure the situation in the rear of a vehiclerear view temporarily. Accordingly, a method for of reducing power consumption of the ECD rearview mirror and rapidly discoloring the ECD is required.

### SUMMARY OF THE INVENTION

The present invention provides an ECD controlling method for of reducing power consumption of an ECD.

The present invention also provides an apparatus for executing the ECD controlling method.

According to an aspect of the present invention, there is provided a method of controlling coloring and discoloring of an ECD using a coloring voltage and a discoloring voltage, respectively, the method including blocking the coloring voltage and the discoloring voltage the coloring voltage and the decoloring voltage are not applied to the ECD after a lapse of predetermined time from the time when the coloring voltage and the discoloring voltages are applied to the ECD.

The discoloring voltage may have a polarity opposite to that of the coloring voltage to promote the discoloring operation.

According to another aspect of the present invention, there is provided an apparatus for controlling coloring and discoloring of an ECD using a coloring voltage and a discoloring voltage, respectively, the apparatus including a comparator comparing a light sensing voltage corresponding to the quantity of light input to the ECD to a reference voltage for coloring the ECD; and a timer switch operated in synchronization with a logic signal output from the comparator, the timer switch applying the coloring voltage or the discoloring voltage to the ECD only for a predetermined time after the timer switch starts to operate.

The apparatus may further comprise a voltage selector selectively applying the coloring voltage or the discoloring voltage to the ECD in response to the comparison result of the comparator.

The voltage selector may selectively apply the coloring voltage or the discoloring voltage having a polarity opposite to that of the coloring voltage to the ECD in response to the comparison result of the comparator. The voltage selector may selectively apply the coloring voltage or the discoloring voltage obtained by inverting the coloring voltage in response to the comparison result of the comparator.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional electrochromic device (ECD);

FIG. 2 illustrates the a configuration of a conventional ECD controller;

FIG. 3 illustrates the a configuration of an ECD controller according to an embodiment of the present invention;

FIG. 4 illustrates the a configuration of a timer switch of FIG. 3;

FIG. 5 illustrates the a configuration of an ECD controller according to another embodiment of the present invention;

FIG. 6 is a diagram for explaining an ECD coloring control operation of the ECD controller of FIG. 5; and

FIG. 7 is a diagram for explaining an ECD discoloring control operation of the ECD controller of FIG. 5.

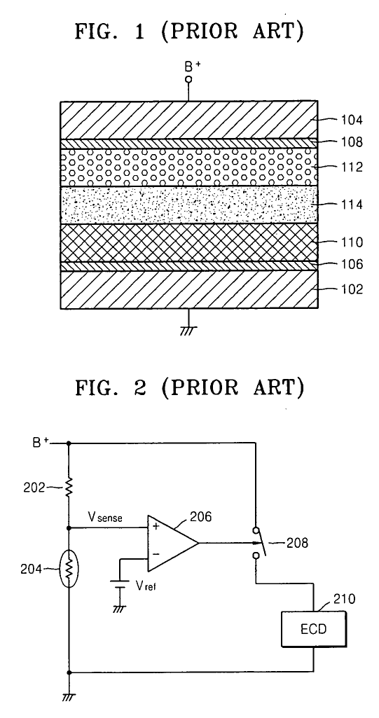

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

The present invention blocks a voltage applied to an electrochromic device (ECD) after after a predetermined predetermined time is passed from the beginning of coloring/discoloring operation by utilizing the memory effect of an inorganic ECD, that is, the effect of maintaining a colored/discolored state even though the voltage applied to the ECD when coloring/discoloring is removed, to thereby minimize power consumption. Furthermore, the present invention applies a voltage opposite to the coloring voltage to the ECD when discoloring in order to accelerate a discoloring speed.

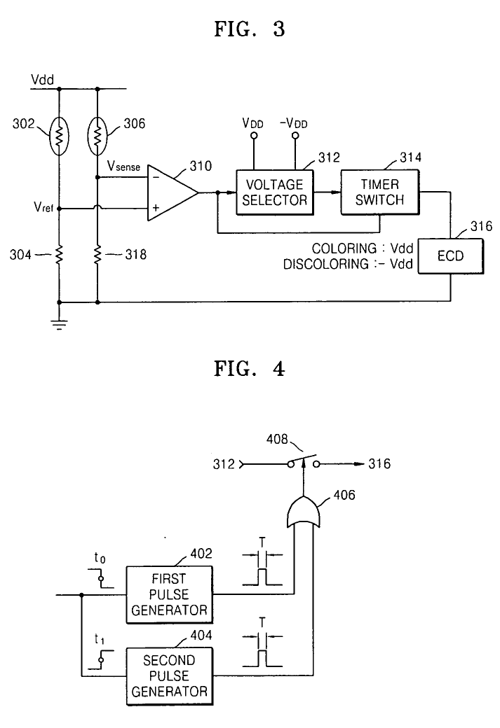

FIG. 3 illustrates the a configuration of an ECD controller according to an embodiment of the present invention. Referring to FIG. 3, the ECD controller includes a comparator 310 comparing a reference voltage Vref to a light sensing voltage Vsense and outputting a logic signal, a voltage selector 312 selecting one of a coloring voltage V_{DD} and a discoloring voltage −V_{DD} in response to the logic signal output from the comparator 310, and a timer switch 314. The reference voltage Vref is obtained at the connection node of a first photoconductive cell 302 and a first resistor 304, which are serially connected between a driving voltage Vdd and a ground voltage, and the light sensing voltage Vsense is obtained at the connection node of a second photoconductive cell 306 and a second resistor 318, which are serially connected between the driving voltage Vdd and the ground voltage.

The first photoconductive cell 302 detects the quantity of light input from the front of a vehicle and the second photoconductive cell 306 detects the quantity of light input from the rear of the vehicle. That is, the ECD controller of FIG. 3 controls the coloring and discoloring of an ECD 316 according to a difference between the quantity of light input from the front of the vehicle and the quantity of light input from the rear of the vehicle.

The voltage selector 312 selects one of the coloring voltage V_{DD} or and the discoloring voltage −V_{DD} in response to the logic signal output from the comparator 310 and outputs the selected one. The comparator 310 compares the reference voltage Vref to the light sensing voltage Vsense, outputs a positive logic signal when the reference voltage Vref is higher than the light sensing voltage Vsense or a negative logic signal when the reference voltage Vref is lower than the light sensing voltage Vsense. In other words, the comparator 310 outputs the a negative logic signal when the quantity of light from the rear of the vehicle is larger than the quantity of light from the front of the vehicle, that is, in a coloring condition, and outputs the a positive logic signal when the quantity of light from the front of the vehicle is larger than the quantity of light from the rear of the vehicle, that is, in a discoloring condition.

The timer switch 314 operates in synchronization with the a rising or falling edge of the output signal of the comparator 310. The timer switch 314 maintains its turned-on state only for a predetermined time after started starting to operate and is then turned off.

On the coloring condition, the comparator 310 outputs the negative logic signal. Then, the voltage selector 312 selects and outputs the coloring voltage V_{DD}. The timer switch 314 is started to operatestarts operating at the time t0 when the coloring condition is satisfied, maintains its turned-on state turned on only for a predetermined time T and is then turned off. Accordingly, the coloring voltage V_{DD} is applied to the ECD 316 at the time t0 when the coloring condition is satisfied to color the ECD 316. The coloring voltage V_{DD} is blocked after a lapse of the predetermined time T. The ECD 316 maintains its colored state due to its memory effect.

On the discoloring condition, the comparator 310 outputs the positive logic signal. Then, the voltage selector 312 selects the discoloring voltage −V_{DD}. The timer switch 314 is turned on only for a predetermined time T from the time t1 when the discoloring condition is satisfied and is then turned off. Accordingly, the discoloring voltage −V_{DD} is applied to the ECD 316 at the time t1 when the discoloring condition is satisfied to discolor the ECD 316. The discoloring voltage −V_{DD} is blocked after a lapse of the predetermined time T. The ECD 316 maintains its discolored state by its memory effect.

FIG. 4 illustrates the a configuration of the timer switch 314 of FIG. 3. Referring to FIG. 4, the timer switch 314 includes a first pulse generator 402 operated at the negative edge of the logic signal output from the comparator 310, a second pulse generator 404 operated at the positive edge of the logic signal output from the comparator 310, an OR gate 406 performing a logic OR operation on ORing the output signals of the first and second pulse generators 402 and 404, and a switch 408 controlled by the OR gate 406.

When the comparator 310 outputs the negative logic signal, the first pulse generator 402 is operated to generate a first pulse signal maintaining a positive state for the predetermined time T. When the comparator 310 outputs the positive logic signal, the second pulse generator 404 is operated to generate a second pulse signal maintaining a positive state for the predetermined time T. Accordingly, the timer switch 314 provides the coloring voltage V_{DD} or the discoloring voltage −V_{DD}, output from the voltage selector 312 only for the time T from the time when the coloring or discoloring condition is satisfied by the operations of the first and second pulse generators 402 and 404, to the ECD 316.

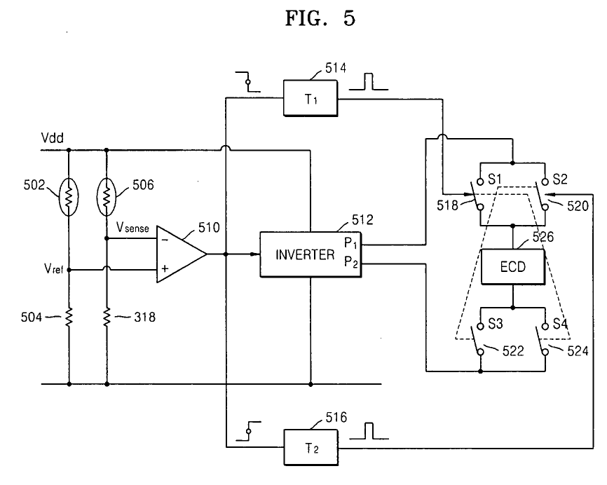

FIG. 5 illustrates the a configuration of an ECD controller according to another embodiment of the present invention. Referring to FIG. 5, the ECD controller includes a comparator 510 comparing a reference voltage Vref to a light sensing voltage Vsense, an inverter 512 performing an inverting operation in response to the an output signal of the comparator 510, a first timer 514 operated in synchronization with the a negative edge of the output signal of the comparator 510, a second timer 516 operated in synchronization with the a positive edge of the output signal of the comparator 510, and four switches 518, 520, 522 and 524 opened and closed by the first and second timers 514 and 516.

The reference voltage Vref is obtained at the connection node of a first photoconductive cell 502 and a first resistor 504, which are serially connected between a driving voltage Vdd and a ground voltage, and the light sensing voltage Vsense is obtained at the connection node of a second photoconductive cell 506 and a second resistor 518, which are serially connected between the driving voltage Vdd and the ground voltage.

The first photoconductive cell 502 detects the quantity of light input from the front of a vehicle and the second photoconductive cell 506 detects the quantity of light input from the rear of the vehicle.

The 4 switches 518, 520, 522 and 524 constructs form a bridge circuit having an ECD 526 as a common path. The 4 switches 518, 520, 522 and 524 are paired into a first switch pair of switches 518 and 524 and a second switch pair of switches 520 and 522 which respectively determine two different paths of the bridge circuit in diagonal directions. The first switch pair of switches 518 and 524 and the second switch pair of switches 520 and 522 are switched to form one of the two different paths in response to the comparison result of the comparator 510.

The inverter 512 outputs a ground voltage GND and a coloring voltage V_{DD} through first and second output terminals P1 and P2 in response to a logic signal output from the comparator 510. Specifically, the inverter 512 outputs the coloring voltage V_{DD} through the first output terminal P1 and outputs the ground voltage GND through the second output terminal P2 when the comparator 510 outputs a negative logic signal. On the contrary, the inverter 512 outputs the ground voltage GND through the first output terminal P1 and outputs the coloring voltage V_{DD} through the second output terminal P2 when the comparator 510 outputs a positive logic signal.

The 4 switches 518, 520, 522 and 524 are operated in pairs. That is, the first timer 514 controls the first and fourth switches switch pair having the first switch 518 and the fourth switch 524 while are controlled in a pair by the first timer 514 the second timer 516 controls the second and third switchesswitch pair having the second switch 520 and the third switch 522 are controlled in a pair by the second switch 516. When the first timer 514 is operated, the coloring voltage V_{DD} and the ground voltage GND are respectively applied to top and bottom terminals of the ECD 526. When the second timer 516 is operated, the ground voltage GND and the coloring voltage V_{DD} are respectively applied to the top and bottom terminals of the ECD 526.

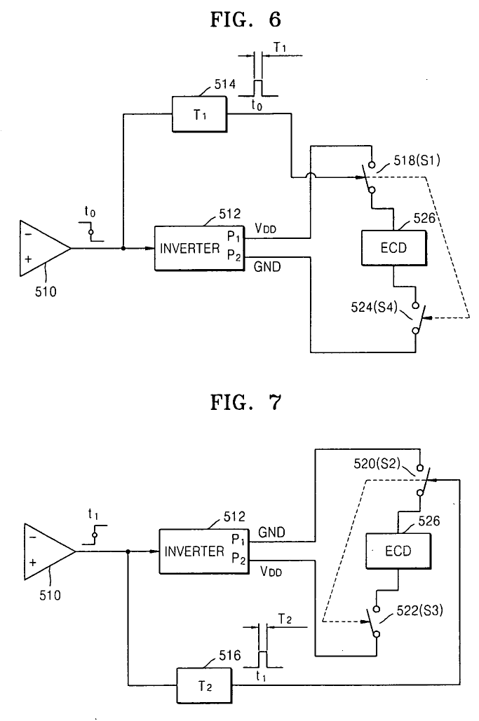

FIG. 6 is a diagram for explaining an ECD coloring control operation of the ECD controller of FIG. 5. The comparator 510 outputs the a negative logic signal when the quantity of light input from the read rear of a vehicle is larger than the quantity of light input from the front of the vehicle, that is, when a coloring condition is satisfied. Accordingly, the inverter 512 respectively outputs the coloring voltage V_{DD} and the ground voltage GND through the first and second output terminals P1 and P2, respectively.

The first timer 514 outputs the first pulse signal maintaining a positive state for a predetermined time T1 in synchronization with the negative edge of the output signal of the comparator 510. The first and fourth switches 518 and 524 controlled by the first timer 514 are turned on for the time 1i in response to the first pulse signal. Consequently, the coloring voltage V_{DD} and the ground voltage GND are respectively applied to the top and bottom terminals of the ECD 526. Accordingly, the ECD 526 is colored for the predetermined time T1 and then maintains its colored state by its memory effect.

FIG. 7 is a diagram for explaining an ECD discoloring control operation of the ECD controller of FIG. 5. The comparator 510 outputs the a positive logic signal when the quantity of light input from the front of the vehicle is larger than the quantity of light input from the rear of the vehicle, that is, when a discoloring condition is satisfied. Accordingly, the inverter 512 respectively outputs the ground voltage GND and the coloring voltage V_{DD} through the first and second output terminals P1 and P2, respectively.

The second timer 516 outputs the second pulse signal maintaining a positive state for a predetermined time T2 in synchronization with the positive edge of the output signal of the comparator 510. The second and third switches 520 and 522 controlled by the second timer 516 are turned on for the time T2 in response to the second pulse signal. Consequently, the ground voltage GND and the coloring voltage V_{DD} are respectively applied to the top and bottom terminals of the ECD 526. Accordingly, the ECD 526 is discolored for the predetermined time T2 and then maintains its discolored state by its memory effect. The ground voltage GND and the coloring voltage V_{DD} are respectively applied to the top and bottom terminals of the ECD 526 in FIG. 7 while the coloring voltage V_{DD} and the ground voltage GND are respectively applied to the top and bottom terminals of the ECD 526 in FIG. 6.

The ECD controllers of FIGS. 3 and 5 apply the voltage, obtained by inverting the voltage applied to the ECDs 326 and 526 to color the ECDs 326 and 526, to the ECDs 316 and 526 to discolor the ECDs 326 and 526, to thereby accelerate a discoloring operation speed. This uses is achieved by utilizing an the oxidation/reduction operation of the ECD 526.

The ECD controllers of FIGS. 3 and 5 block the coloring voltage and the discoloring voltage applied to the ECDs 326 and 526 after a predetermined predetermined time is passed from when coloring and discoloring operations are started. Even though the coloring voltage and the discoloring voltage are blocked, the ECDs 326 and 526 maintain colored and discolored states by their memory effect. Accordingly, the ECDs 326 and 526 require small power consumption because they perform the coloring and discoloring operations only for a predetermined time.

The ECD controllers of FIGS. 3 and 5 carry out the coloring and discoloring operations only for a predetermined time and then maintain the colored and discolored states by their memory effect to extend the life spans of them.

The ECD controller of FIG. 5 is more effective when the coloring and discoloring operations are rapidly switched. This is because the coloring and discoloring operations can be carried out at any time irrespective of the state of the ECD 526 since the coloring voltage and the discoloring voltage are respectively applied to the ECD 526 through different paths.

As described above, the ECD controller according to the present invention reduces power consumption of the ECD by blocking coloring and discoloring voltages applied to the ECD after after a lapse of predetermined time is passed from the start of coloring and discoloring operations. Furthermore, the ECD controller according to the present invention accelerates a discoloring operation speed by applying a voltage obtained by inverting the coloring voltage to the ECD.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for of controlling an ECD coloring and discoloring of an ECD colored and decolored by using a coloring voltage and a discoloring voltage, respectively, the method comprising blocking the coloring voltage and the discoloring voltage the coloring voltage and the decoloring voltage are not applied to the ECD after a lapse of predetermined time from the time when the coloring voltage and the discoloring voltages are applied to the ECD.

2. The method of claim 1, wherein the discoloring voltage has a polarity opposite to that of the coloring voltage.

3. An apparatus for controlling an ECD coloredcoloring and decolored discoloring of an ECD by using a coloring voltage and a discoloring voltage, respectively, comprising:
a comparator comparing a light sensing voltage corresponding to the quantity of light input to the ECD to a reference voltage for coloring the ECD; and
a timer switch operated in synchronization with a logic signal output from the comparator, the timer switch applying the coloring voltage or the discoloring voltage to the ECD only for a predetermined time after the timer switch startsstarted to operate.

4. The apparatus of claim 3, further comprising a voltage selector selectively applying the coloring voltage or the discoloring voltage to the ECD in response to the comparison result of the comparator.

5. The apparatus of claim 4, wherein the voltage selector selectively applies the coloring voltage or the discoloring voltage having a polarity opposite to that of the coloring voltage to the ECD in response to the comparison result of the comparator.

6. The apparatus of claim 4, wherein the voltage selector selectively applies the coloring voltage or the discoloring voltage obtained by inverting the coloring voltage in response to the comparison result of the comparator.

7. The apparatus of claim 6, further comprising four switches constructing a bridge circuit having the ECD as a common path, wherein the four switches constructs first and second switch pairs respectively determining two different paths of the bridge circuit in diagonal directions, the first and second switch pairs being switched to form one of the two different paths in response to the comparison result of the comparator.
